(19) United States
(12) Patent Application Publication
(10) Pub. No.: US 2009/0027428 A1
(43) Pub. Date: Jan. 29, 2009

(54) Inkjet Apparatus and Inkjet Control Method

(75) Inventor: Chiyoshi Yoshioka, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka-shi (JP)

(21) Appl. No.: 11/922,288

(22) PCT Filed: Jun. 13, 2006
(86) PCT No.: PCT/JP2006/311849

§ 371 Date: May 30, 2008

(30) Foreign Application Priority Data
Jun. 14, 2005 (JP) 2005-174379
Jan. 13, 2006 (JP) 2006-006672

(51) Int. Cl. B41J 29/38

(52) U.S. Cl. 347/9

(57) ABSTRACT

The inkjet apparatus of the present invention includes an inkjet section, a determination section, an inkjet control section, and the like, and the inkjet section is movable in a main scanning direction Y and a sub scanning direction X relative to a medium. In case where a plurality of pixel print targets (2) (inkjet targets) are dotted on a substrate (4) serving as the medium, the determination section calculates a time Yt taken to move in the main scanning direction and a time Xt taken to move in the sub scanning direction and determines whether or not the time Xt is equal to or less than Yt, so as to select a next inkjet target or next inkjet target candidates. Further, the inkjet control section may determine whether the inkjet section is in a static state or not (whether the inkjet section oscillates or not). As a result, it is possible to eject ink to the inkjet target accurately.

### TECHNICAL FIELD

The present invention relates to an inkjet apparatus and an inkjet control method each of which allows ink to be ejected to an inkjet target with accuracy.

### BACKGROUND ART

Recently, a technique for ejecting ink has been widely applied not only to a consumer printer but also to a liquid crystal CF (Color Filter) panel manufacturing apparatus or other manufacturing apparatus, and its purpose of use has been diversified.

An example thereof is an inkjet patterning technique in which a pattern is formed on a substrate by using an inkjet technique. The inkjet patterning technique is such that a minute amount of liquid such as ink is ejected from an inkjet apparatus so as to print a minute pattern directly on a substrate. Instead of a conventional pattern formation method adopting a vacuum process with photolithography, the inkjet patterning technique has attracted attentions as a technique which exceeds the vacuum process.

Recently, development of an apparatus for forming a CF panel by adopting the inkjet patterning technique has been promoted. The apparatus causes ink droplets of red (R), green (G), and blue (B) to be landed on a glass substrate so as to be positioned respectively in R, G, B pixels, thereby filling the respective pixels with the ink droplets. In this manner, the CF panel is formed. The apparatus is used to manufacture a liquid crystal CF panel whose area size has been increased recently. Further, a processing time of the apparatus is strictly managed, and it is required to complete processes within a short time period with accuracy.

According to a conventional CF panel, as illustrated in FIG. 7, pixels 101 each of which serves as a print target are disposed both in a main scanning direction Y and a sub scanning direction X so as to be in a lattice manner. Thus, according to a printing method in entire pixels of the conventional CF panel, generally, an inkjet head moves in the main scanning direction Y and then turns in a perpendicular direction so as to be in the sub scanning direction X, and this movement is repeated so as to move to a target position, and then the inkjet head ejects ink (for example, see Patent Document 1). Note that, a moving path of the inkjet head is indicated by an arrow in FIG. 7.

Further, the inkjet patterning technique is widely applicable not only as a technique for printing the pixels entirely but also as a technique for restoring a defective pixel in which colors are mixed or foreign substances are mixed or adhere (for example, see Patent Document 2). In order to restoring the defective pixel, a laser device or the like removes an ink layer of the defective pixel in which mixture of ink colors occurs between pixels adjacent to each other due to ink leakage or the like, ink whose color is specified out of red, green, and blue is ejected to the part, from which the ink layer has been removed, in accordance with the inkjet patterning technique.

In moving the inkjet head of the inkjet apparatus to the defective pixel at the time of the restoration, the inkjet head is moved into two dimensional directions in accordance with X-Y coordinates of the restoration position, and a predetermined number of droplets of ink are ejected upon reaching the target position, thereby recover the defective pixel. As the method for moving the inkjet head in the two dimensional directions, an XY plotter method or a method in which movement in the main scanning direction and movement in the sub scanning direction are alternately repeated is widely adopted.

The XY plotter method is such that: in case where the main scanning direction is a Y coordinate axis direction, defective pixels are rearranged simply in accordance with a Y coordinate value, and the thus rearranged defective pixels are restored in an ascending order or a descending order. For example, as illustrated in FIG. 8, a plurality of pixel print targets 202 exist on a substrate 204. In this case, according to the XY plotter method, the defective pixels of the pixel print targets 202 are sequentially restored, in such order that defective pixels whose Y coordinate axis values are larger are more preferentially restored, while moving the inkjet head. At this time, acceleration and deceleration of the movement of the inkjet head into the main scanning direction Y and the sub scanning direction X are repeated. Note that, an arrow of FIG. 8 indicates a moving path of the inkjet head. As illustrated in FIG. 8, according to the foregoing method, the inkjet head moves straight between the pixel print targets 202.

Further, according to the method in which movement in the main scanning direction and movement in the sub scanning direction are alternately repeated, the defective pixels are restored while moving the inkjet head into the main scanning direction, and then the inkjet head moves in the sub scanning direction. After finishing the movement in the sub scanning direction, the defective pixels are restored while moving the inkjet head in the main scanning direction. In this way, the foregoing method is such that the movement in the main scanning direction and the movement in the sub scanning direction are alternately repeated. For example, as illustrated in FIG. 9, a plurality of pixel print targets 302 exist on a substrate 304. In this case, according to the foregoing method, the pixel print targets 302 are restored while moving the inkjet head only in the main scanning direction Y. When the restoration is completed, the inkjet head moves only in the sub scanning direction X without moving in the main scanning direction Y. Thus, according to the foregoing method, acceleration and deceleration of the inkjet head in the main scanning direction Y and the sub scanning direction X are repeated. Note that, an arrow of FIG. 9 indicates a moving path of the inkjet head. As illustrated in FIG. 9, according to the foregoing method, the inkjet head moves between the pixel print targets 301 in a zigzag manner.

[Patent Document 1]

Japanese Unexamined Patent Publication No. 306617/2004 (Tokukai 2004-306617)(Publication date: Nov. 4, 2004)

[Patent Document 2]

Japanese Unexamined Patent Publication No. 66218/2003 (Tokukai 2003-66218)(Publication date: Mar. 5, 2003)

However, according to the conventional arrangement, in case where the inkjet head of the inkjet apparatus moves to an inkjet target, a moving speed of the inkjet head greatly varies, so that a great load is exerted to the apparatus and it takes long time to carry out the restoration so as to keep accuracy with which a droplet of ink is landed.

Specifically, according to the XY plotter method or the method in which movement in the main scanning direction and movement in the sub scanning direction are alternately repeated, the inkjet head moves on the substrate with acceleration and deceleration.

However, in order to land the ink droplet on the inkjet target with high accuracy, the inkjet head has to eject ink with less acceleration and less deceleration. Thus, in either of the two methods, the inkjet head has to move at a constant speed just before printing. As a result, there occurs such a problem that the inkjet head has to repeat operations accompanied with acceleration and deceleration, in other words, the inkjet head has to repeat operations accompanied with loads. Further, a time period for making the speed constant is required, so that it takes long time to carry out the processes.

For example, in a large manufacturing apparatus, a device which causes the substrate to move by driving in stages is provided instead of the inkjet head. In case of the manufacturing apparatus, it is important to move a heavy substrate without carrying out acceleration and deceleration as much as possible. In a large manufacturing apparatus used in manufacturing a liquid crystal CF panel, recently, the following operations have been required: plural droplets whose amount is several pico liter are landed on a several-meter large glass substrate so as to be positioned in a pixel region whose each side is several dozens to several hundreds μm and the pixel is filled with ink. In order to realize this condition, it is essential to keep the position of the substrate with extremely high accuracy and to land ink on the substrate with extremely high accuracy. Thus, if the moving direction or the moving speed is suddenly changed, this raises a serious problem in the patterning which requires high accuracy in landing ink.

Further, according to the conventional arrangement, it is important to move the inkjet head to a target position at an extremely high speed so as to shorten the time period taken to carry out the processes. In case of changing the position of the inkjet head at a high speed in this manner, it is extremely preferable to keep the inkjet head, which is ejecting ink, in a static state. Specifically, if the inkjet head ejects ink while vibrating, the ink is landed on the substrate less accurately. Particularly, in case where it is necessary to land the ink with higher accuracy, the inkjet head's stability in ejecting ink is an important condition. For example, according to study carried out by the present inventors, it was found that: even if the inkjet head slightly vibrates, a position in which ink is landed deviates by several μm to dozens μm, depending on cases, by several hundreds μm.

Thus, if the inkjet head is not in the static state, ink is highly likely to be dropped on a position other than the inkjet target. As a result, the substrate which is the inkjet target is more likely to be impaired, so that the yield drops, which results in the higher manufacturing cost.

Further, according to the conventional arrangement, a nozzle which so quickly moves in the main scanning direction is used to eject ink to the inkjet target. In this case, a clogged nozzle or a similar factor may result in an insufficient amount of ink ejected. In order to solve this problem, a printing speed in the main scanning direction may be lowered, but this method raises such a problem that it takes longer time to carry out the processes. Further, it is possible to adopt a method in which ink is ejected to the inkjet target in several doses, but this method raises such a problem that this increases the time period taken to carry out the processes. Further, it is possible to adopt a method in which an amount of ink droplet ejected from a single nozzle is increased, but this method raises such a problem that it is difficult to land the ink on a small inkjet target with high accuracy.

### DISCLOSURE OF INVENTION

The present invention was made in view of the foregoing problems, and an object of the present invention is to provide an inkjet apparatus and an inkjet control method each of which allows ink to be landed on each of plural dotted inkjet targets with high accuracy and allows an inkjet process to be carried out in a short processing time.

In order to solve the foregoing problems, an inkjet apparatus of the present invention comprises inkjet means which is provided movably between a plurality of inkjet targets dotted on a medium so as to eject ink to each of the inkjet targets, said inkjet apparatus being characterized in that: the inkjet means is movable, in a main scanning direction and a sub scanning direction, relative to the medium, said inkjet apparatus further comprising determination means for carrying out at least a process for selecting a next inkjet target or inkjet target candidates to which ink is ejected subsequently to a first inkjet target which is an arbitrary inkjet target, wherein the determination means calculates a main scanning direction movement time and a sub scanning direction movement time in moving from the first inkjet target to other inkjet target and determines whether the sub scanning direction movement time is equal to or less than the main scanning direction movement time or not at least so as to select a next inkjet target or next inkjet target candidates as a result of that determination.

Further, in order to solve the foregoing problems, an inkjet control method of the present invention is an inkjet control method of an inkjet apparatus including inkjet means, said inkjet means being provided movably between a plurality of inkjet targets dotted on a medium so as to eject ink to each of the inkjet targets and being movable in a main scanning direction and a sub scanning direction and moves relative to the medium, said inkjet control method comprising the determination step of carrying out at least a process for selecting a next inkjet target or inkjet target candidates to which ink is ejected subsequently to a first inkjet target which is an arbitrary inkjet target, said determination step being carried out at a stage before the inkjet means ejects ink, wherein: in the determination step, there are calculated a main scanning direction movement time and a sub scanning direction movement time in moving from the first inkjet target to other inkjet target and there is determined whether the sub scanning direction movement time is equal to or less than the main scanning direction movement time or not at least so as to select a next inkjet target or next inkjet target candidates as a result of that determination.

According to the arrangement, the determination means determines inkjet targets, each of which has the sub scanning direction movement time (Xt) equal to or less than the main scanning direction movement time (Yt), as next inkjet target candidates. Thus, in case where the inkjet means moves between two inkjet targets, the inkjet means finishes movement in the sub scanning direction before finishing movement in the main scanning direction. In this case, the inkjet means moves at a constant speed only in the main scanning direction in ejecting ink to the inkjet target. That is, ink is ejected without any change of the speed. Thus, ink can be ejected to the inkjet target with less acceleration and less deceleration, so that it is possible to eject ink with high accuracy. Further, the inkjet means moves in the main scanning direction without increasing or decreasing its moving speed, so that it is possible to decrease a load exerted to the inkjet means.

It is preferable to arrange the inkjet apparatus of the present invention so that: in case where the main scanning direction movement time of the inkjet means is indicated as Yt and the sub scanning direction movement time of the inkjet means is indicated as Xt, the determination means determines inkjet targets, each of which has Xt equal to or less than Yt (Xt≦Yt), as inkjet target candidates, said inkjet apparatus further comprising ejection order determination means for determining, out of the next inkjet target candidates, an inkjet target, which can be reached from the first inkjet target in a shortest time, as the next inkjet target.

Further, it is preferable to arrange the inkjet control method of the present invention so that: in case where the main scanning direction movement time of the inkjet means is indicated as Yt and the sub scanning direction movement time of the inkjet means is indicated as Xt, inkjet targets, each of which has Xt equal to or less than Yt (Xt≦Yt), are determined as inkjet target candidates in the determination step, said inkjet control method further comprising the ejection order determination step of determining, out of the next inkjet target candidates, an inkjet target, which can be reached from the first inkjet target in a shortest time, as the next inkjet target.

According to the arrangement, the determination means determines inkjet targets, each of which has the sub scanning direction movement time (Xt) equal to or less than the main scanning direction movement time (Yt), as next inkjet target candidates. Thus, in case where the inkjet means moves between two inkjet targets, the inkjet means finishes movement in the sub scanning direction before finishing movement in the main scanning direction. In this case, the inkjet means moves at a constant speed only in the main scanning direction in ejecting ink to the inkjet target. That is, ink is ejected without any change of the speed. Thus, ink can be ejected to the inkjet target with less acceleration and less deceleration, so that it is possible to eject ink with high accuracy. Further, the inkjet means moves in the main scanning direction without increasing or decreasing its moving speed, so that it is possible to decrease a load exerted to the inkjet means.

Further, the ejection order determination means determines, out of the next inkjet target candidates, an inkjet target, which can be reached from the first inkjet target in a shortest time, as a next inkjet target. Thus, the ejection order determination means determines the next inkjet target which can be reached earlier than the reference time, so that it is possible to carry out the inkjet process in a short processing time. As a result, it is possible to provide an inkjet apparatus and an inkjet control method each of which allows ink to be landed on each of the plural dotted inkjet targets with high accuracy and the inkjet process to be carried out in a short processing time.

It is preferable to arrange the inkjet apparatus of the present invention: in case where the main scanning direction movement time of the inkjet means is indicated as Yt and the sub scanning direction movement time of the inkjet means is indicated as Xt, the determination means calculates Yt and Xt so that the calculation is more preferentially carried out with respect to inkjet targets positioned nearer to the first inkjet target and determines whether or not Xt is equal to or less than Yt (Xt≦Yt), and the determination means determines an inkjet target, satisfying a condition represented by Xt≦Yt, as the next inkjet target.

Further, it is preferable to arrange the inkjet control method of the present invention so that: in case where the main scanning direction movement time of the inkjet means is indicated as Yt and the sub scanning direction movement time of the inkjet means is indicated as Xt, there are calculated Yt and Xt so that the calculation is more preferentially carried out with respect to inkjet targets positioned nearer to the first inkjet target and there is determined whether or not Xt is equal to or less than Yt (Xt≦Yt) in the determination step, and an inkjet target, satisfying a condition represented by Xt≦Yt, is determined as the next inkjet target.

According to the arrangement, the determination means determines inkjet targets, each of which has the sub scanning direction movement time (Xt) equal to or less than the main scanning direction movement time (Yt), as next inkjet target candidates. Thus, in case where the inkjet means moves between two inkjet targets, the inkjet means finishes movement in the sub scanning direction before finishing movement in the main scanning direction. In this case, the inkjet means moves at a constant speed only in the main scanning direction in ejecting ink to the inkjet target. That is, ink is ejected without any change of the speed. Thus, ink can be ejected to the inkjet target with less acceleration and less deceleration, so that it is possible to eject ink with high accuracy. Further, the inkjet means moves in the main scanning direction without increasing or decreasing its moving speed, so that it is possible to decrease a load exerted to the inkjet means.

Further, the determination means determines whether the sub scanning direction movement time (Xt) is equal to or less than the main scanning direction movement time (Yt) or not so as to determine an inkjet target, which satisfies Xt≦Yt, as a next inkjet target, in such order that the determination is more preferentially carried out with respect to inkjet targets positioned nearer to the first inkjet target. Thus, when an inkjet target existing in a position satisfying Xt≦Yt is first found, the inkjet target is determined as a next inkjet target. Therefore, it is possible to determine the next inkjet target without using the ejection order determination means.

Further, as to an inkjet target which has not been determined as the next inkjet target as a result of the calculation to find whether the inkjet target satisfies Xt≦Yt or not at the time when the next inkjet target is determined, it is not necessary to carry out calculation and determination. As a result, it is possible to reduce the processing time.

As a result, it is possible to provide an inkjet apparatus and an inkjet control method each of which allows ink to be landed onto each of the plural dotted inkjet targets with high accuracy and allows the inkjet process to be carried out in a short processing time.

It is preferable to arrange the inkjet apparatus of the present invention so that: in case where a moving distance in a Y coordinate axis direction is indicated as Y₁ (mm), a constant moving speed in the Y coordinate axis direction is indicated as a (mm/second), a time required in acceleration in an X coordinate axis direction is indicated as d₁ (second), a time required in deceleration in the X coordinate axis direction is indicated as d₂ (second), a time required in stoppage in the X coordinate axis direction is indicated as c (second), each of a moving distance in the X coordinate axis direction in the acceleration and a moving distance in the X coordinate axis direction in the deceleration is indicated as X₂ (mm), and a speed at which constant movement is carried out in the X coordinate axis direction is indicated as b (mm/second), the determination means determines inkjet targets, each of which has the sub scanning direction movement time (Xt) calculated by an expression (I) and the main scanning direction movement time (Yt) calculated by an expression (II) so that a condition represented by an expression (III) is satisfied, as the next inkjet target candidates,

Xt=(X₁−2×X₂)/b+(d₁+d₂)+c (I)

Yt=Y₁/a (II)

Xt≦Yt (III).

Further, it is preferable to arrange the inkjet control method of the present invention so that: in case where a moving distance in a Y coordinate axis direction is indicated as Y₁ (mm), a constant moving speed in the Y coordinate axis direction is indicated as a (mm/second), a time required in acceleration in an X coordinate axis direction is indicated as d₁ (second), a time required in deceleration in the X coordinate axis direction is indicated as d₂ (second), a time required in stoppage in the X coordinate axis direction is indicated as c (second), each of a moving distance in the X coordinate axis direction in the acceleration and a moving distance in the X coordinate axis direction in the deceleration is indicated as X₂ (mm), and a speed at which constant movement is carried out in the X coordinate axis direction is indicated as b (mm/second), inkjet targets, each of which has the sub scanning direction movement time (Xt) calculated by an expression (I) and the main scanning direction movement time (Yt) calculated by an expression (II) so that a condition represented by an expression (III) is satisfied, are determined as the next inkjet target candidates in the determination step,

Xt=(X₁−2×X₂)/b+(d₁+d₂)+c (I)

Yt=Y₁/a (II)

Xt≦Yt (III).

According to the arrangement, Xt and Yt of each of the plural inkjet targets are calculated in accordance with the expressions (I) and (II), so that the thus calculated values can be compared with each other. As a result, an inkjet target satisfying the condition indicated by the expression (III) is determined as a next inkjet target candidate. In other words, the inkjet apparatus can select an inkjet target to which ink can be ejected while moving at a constant speed.

It is preferable to arrange the inkjet apparatus of the present invention so as to further comprise inkjet control means for carrying out at least such control that the inkjet means is moved relative to an inkjet target in accordance with an order, in which ink is ejected to the inkjet targets, and the inkjet means ejects ink to the inkjet target.

Further, it is preferable to arrange the inkjet control method of the present invention so as to further comprises the inkjet control step of carrying out at least such control that the inkjet means is moved relative to an inkjet target in accordance with an order, in which ink is ejected to the inkjet targets, and the inkjet means ejects ink to the inkjet target.

According to the arrangement, it is possible to obtain various information concerning the inkjet means which information is required in ejecting ink to the inkjet target with high accuracy.

It is preferable to arrange the inkjet apparatus of the present invention so that the inkjet control means includes: head static state monitoring means for monitoring whether the inkjet means is in a static state or not; and head position observing means for detecting a position of the inkjet means.

Further, it is preferable to arrange the inkjet control method of the present invention so that the inkjet control step includes: the head static state monitoring step of monitoring whether the inkjet means is in a static state or not; and the head position observing step of detecting a position of the inkjet means.

According to the arrangement, it is possible to confirm whether the inkjet means is in such a static state that there is no influence on accuracy with which ink is landed.

It is preferable to arrange the inkjet apparatus of the present invention so as to further comprises inkjet determination means for determining whether the inkjet means is capable of ejecting ink in reaching an inkjet start point or not in accordance with a monitoring result of the head static state monitoring means and an observing result of the head position observing means.

Further, it is preferable to arrange the inkjet control method of the present invention so as to further comprises the inkjet determination step of determining whether the inkjet means is capable of ejecting ink in reaching an inkjet start point or not in accordance with a monitoring result of the head static state monitoring step and an observing result of the head position observing step.

According to the arrangement, in case where the inkjet means is not in the static state in ejecting ink, it is possible to determine that ink is less accurately landed, so that it is possible to cause the inkjet determination means to stop ejection of ink.

It is preferable to arrange the inkjet apparatus of the present invention so as to further comprise inkjet stoppage position management means for managing an ink ejection position and an inkjet stoppage position in accordance with the monitoring result of the head static state monitoring means and the observing result of the head position observing means.

Further, it is preferable to arrange the inkjet control method of the present invention so as to further comprise the inkjet stoppage position management step of managing an ink ejection position and an inkjet stoppage position in accordance with the monitoring result of the head static state monitoring step and the observing result of the head position observing step.

According to the arrangement, a position in which ink ejection is stopped due to an unstable state of the head or a similar state can be saved, so that an inkjet target in that position can be managed out of the inkjet targets dotted on the medium.

It is preferable to arrange the inkjet apparatus of the present invention so that the inkjet control means includes incompletely-inked target extraction means for extracting an inkjet target with respect to which inkjet is stopped.

Further, it is preferable to arrange the inkjet control method so that the inkjet control step includes the incompletely-inked target extraction step of extracting an inkjet target with respect to which inkjet is stopped.

According to the arrangement, it is possible to extract an inkjet target with respect to which ink ejection has been stopped so that the ink has not been completely landed.

It is preferable to arrange the inkjet apparatus of the present invention so that the inkjet means is moved again to the inkjet target extracted by the incompletely-inked target extraction means and is made to eject ink to the inkjet target.

Further, it is preferable to arrange the inkjet control method of the present invention so that the inkjet means is moved again to the inkjet target extracted by the incompletely-inked target extraction step and is made to eject ink to the inkjet target.

According to the arrangement, the head can be moved again to the inkjet target, to which ink has not been ejected, so as to eject ink.

It is preferable to arrange the inkjet apparatus of the present invention so that the inkjet means inclines in the main scanning direction or the sub scanning direction with the inkjet means positioned opposite to the inkjet target.

Further, it is preferable to arrange the inkjet control method so that the inkjet means inclines in the main scanning direction or the sub scanning direction with the inkjet means positioned opposite to the inkjet target.

According to the arrangement, the inkjet means inclines in the main scanning direction or the sub scanning direction with the inkjet means positioned opposite to the inkjet target, so that it is possible to decease a distance between the nozzles in the sub scanning direction. In other words, it is possible to increase or decrease the number of nozzles passing above a single inkjet target. As a result, it is possible to eject ink to the same inkjet target by using a plurality of nozzles. For example, in case of ejecting a large amount of ink to a single inkjet target, the inkjet means is inclined, so that it is possible to eject a necessary amount of ink at once by using a necessary number of nozzles for ejecting the necessary amount of ink. Further, it is possible to eject ink to the same inkjet target by using a plurality of nozzles. Thus, even if a part of the nozzles for ejecting ink becomes unable to eject ink, the rest of the nozzles in a normal state can eject ink to the inkjet target.

It is preferable to arrange the inkjet apparatus of the present invention so that the inkjet means ejects ink to a plurality of inkjet targets during a single scanning operation.

Further, it is preferable to arrange the inkjet control method of the present invention so that the inkjet means ejects ink to a plurality of inkjet targets during a single scanning operation.

According to the arrangement, ink can be ejected to a plurality of inkjet targets adjacent to each other during a single scanning operation for example. As a result, it is possible to reduce the entire processing time.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1, showing an embodiment of the present invention, is a schematic illustrating an order in which ink is ejected to inkjet targets in accordance with an inkjet apparatus and an inkjet control method.

FIG. 2 is a block diagram illustrating an arrangement of the inkjet apparatus.

FIG. 3 is a flowchart illustrating the inkjet control method.

FIG. 4(a) is a schematic illustrating a process for ejecting ink to each of vertically long inkjet targets.

FIG. 4(b) is a schematic illustrating a process for ejecting ink to each of horizontally long inkjet targets.

FIG. 5(a) is a schematic illustrating positions of nozzles in case where an inkjet head is not inclined in the inkjet apparatus.

FIG. 5(b) is a schematic illustrating positions of the nozzles in case where the inkjet head is inclined in the inkjet apparatus.

FIG. 6(a) is a schematic illustrating positions of the nozzles in case where two pixels adjacent to each other are restored at the same time in the inkjet apparatus.

FIG. 6(b) is a schematic illustrating positions of the nozzles in case where three pixels adjacent to one other are restored at the same time in the inkjet apparatus.

FIG. 7 is a schematic illustrating an order in which defective portions are restored in accordance with a conventional method in which scanning in a main scanning direction and scanning in a sub scanning direction are alternately carried out.

FIG. 8 is a schematic illustrating an order in which defective portions are restored in accordance with a conventional XY plotter method.

FIG. 9 is a schematic illustrating an order in which defective portions are restored in accordance with the conventional method in which scanning in a main scanning direction and scanning in a sub scanning direction are alternately carried out.

FIG. 10, showing another embodiment of the present invention, is a block diagram detailing an arrangement of an inkjet apparatus.

FIG. 11 is a flowchart illustrating how an inkjet control section of the inkjet apparatus operates.

FIG. 12 is a schematic illustrating a static state of an inkjet section, which static state is monitored by the inkjet control section, in view of a positional relation between a nozzle of the inkjet section and a medium.

### REFERENCE NUMERALS

1 Pixel
2 Pixel print target
3 Substrate
10 Information input section
11 Processing section
12 Data input section
13 Determination section (determination means)
14 Order determination section (ejection order determination means)
15 Inkjet control section
16 Inkjet section (inkjet means)
20 Inkjet head
Head static state monitoring section
25 Head position control section
26 Inkjet determination section
27 Head ejection stoppage position management section
28 Incompletely-inked target extraction section
29 Inkjet section movement control section

### BEST MODE FOR CARRYING OUT THE INVENTION

### Embodiment 1

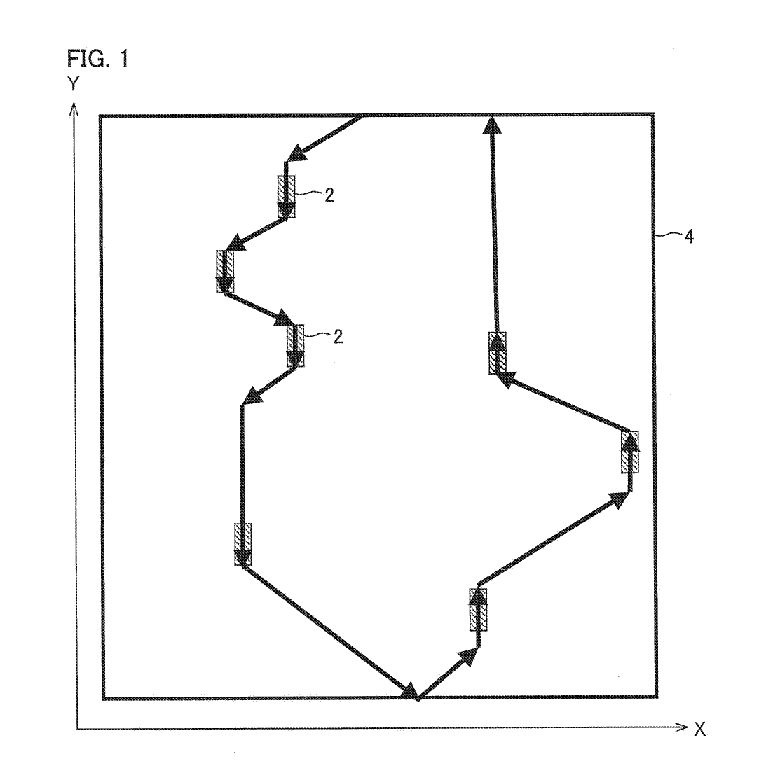

The following description will explain an embodiment of the present invention with reference to FIG. 1 to FIG. 6, but the present invention is not limited to this.

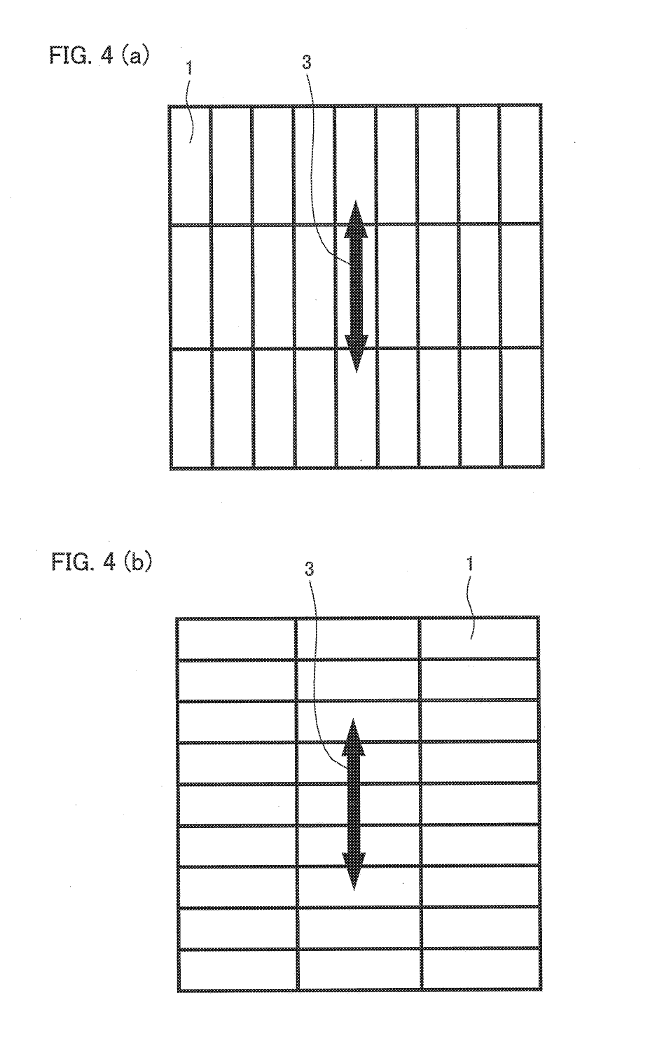

Note that, in the present embodiment, a main scanning direction is referred to as “Y coordinate axis direction” and a sub scanning direction is referred to as “X coordinate axis direction”. Further, as an embodiment of the present invention, the following description taking, as an example, a case of carrying out CF defective pixel restoration in which CF panel pixels dotted on a substrate and targeted in restoration are recovered by inkjet. As such, inks of three colors, i.e., red (R), green (G), and blue (B) inks are used, and the restored portion is indicated by a substantially-rectangular region corresponding to the pixel portion. Note that, depending on placement of a panel substrate, the substantially-rectangular region may be vertically long or horizontally long due to variation of a scanning direction of the inkjet apparatus as illustrated in FIG. 4, and the present invention covers both the case where the substantially-rectangular region is vertically long and the case where the substantially-rectangular region is horizontally long. Note that, in FIG. 4, the scanning direction of the inkjet apparatus is indicated by an arrow 3.

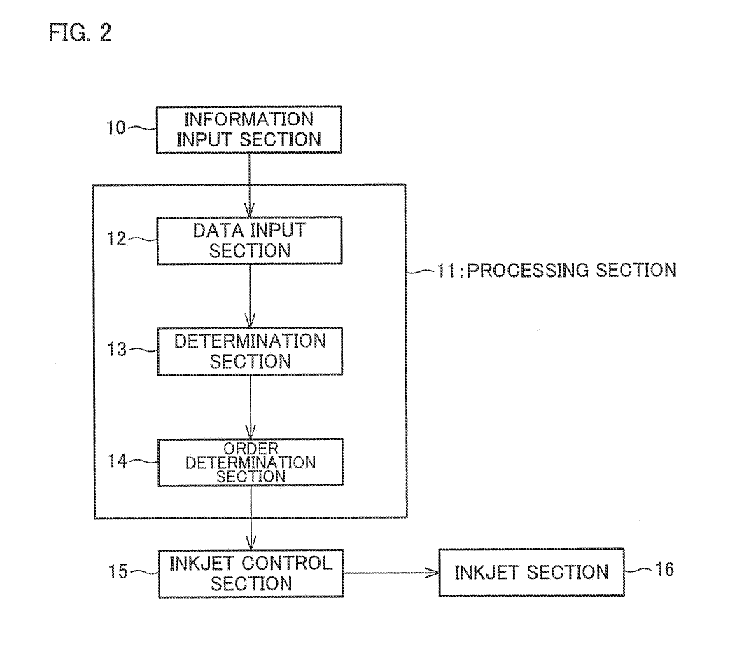

First, an arrangement of the inkjet apparatus of the present embodiment is described as follows with reference to FIG. 2.

The inkjet apparatus of the present embodiment includes an information input section 10, a processing section 11, an inkjet control section 15, and an inkjet section 16 (inkjet means). Further, the processing section 11 includes a data input section 12, a determination section 13 (determination means), and an order determination section 14 (ejection order determination means).

In the inkjet apparatus of the present invention, the inkjet section 16 is movable relative to a medium (not shown). In other words, the inkjet apparatus of the present invention may be arranged as follows: (1) a known moving member allows the inkjet section 16 to move relative to a medium fixed by a known fixing member; (2) a known moving member allows the medium to move relative to the inkjet section 16 fixed by a known fixing member; or (3) a known moving member allows both the inkjet section 16 and the medium to move. Note that, specific arrangements of the fixing member and the moving member are not particularly limited, and an arrangement known in the technical field of the present invention can be suitably adopted.

How the inkjet section 16 moves relative to the medium is controlled by the inkjet control section 15. For example, according to the arrangement (1), how the inkjet section 16 is moved by the moving member is controlled; according to the arrangement (2), how the medium is moved by the moving member is controlled; according to the arrangement (3), how both the inkjet section 16 and the medium are moved by the moving member is controlled. Note that, how to specifically control the movement and how to control to determine a position of the inkjet section 16 relative to the medium are described later by taking the arrangement (1) as an example.

In the inkjet apparatus of the present embodiment, information or the like on an inkjet target is inputted via the information input section 10. The information input section 10 inputs information or the like on plural dotted inkjet targets to the data input section 12. As the information, any information is adopted as long as the information is used to determine an order in which ink is ejected to the plural inkjet targets dotted on the medium, so that the information is not particularly limited. An example thereof is positional information indicative of a position on the CF panel in which position the inkjet target exists. Further, the information input section 10 can be arranged in a known manner and the arrangement of the information input section 10 is not particularly limited. For example, it may be so arranged that an image recognition device or the like including a camera or the like recognizes the inkjet target and then obtains position information thereof so as to input the information to the data input section 12.

The data input section 12 receives the information from the information input section 10. The thus received information is inputted to the determination section 13. The data input section 12 is not particularly limited and a known arrangement can be suitably adopted thereto.

The determination section 13 determines a first inkjet target in accordance with the information inputted from the data input section 12 and regards the first inkjet target as a beginning point. How to determine the beginning point is not particularly limited. For example, an inkjet target whose Y coordinate axis value is largest may be selected from the plural inkjet targets dotted on the medium or an inkjet target whose Y coordinate axis value is smallest may be selected from the plural inkjet targets dotted on the medium. Alternatively, an inkjet target positioned nearest to the inkjet section 16 can be selected as the beginning point.

Further, in case of regarding an arbitrary inkjet target as the first inkjet target in accordance with the information inputted from the data input section 12, the determination section 13 calculates a main scanning direction movement time (Yt) and a sub scanning direction movement time (Xt) when the inkjet section 16 moves from the first inkjet target to other inkjet target, and the determination section 13 determines inkjet targets, each of which has the sub scanning direction movement time (Xt) equal to or less than the main scanning direction movement time (Yt), as next inkjet target candidates.

Further, in case of determining an arbitrary inkjet target as the first inkjet target in accordance with the information inputted from the data input section 12, the determination section 13 calculates a main scanning direction movement time (Yt) and a sub scanning direction movement time (Xt) when the inkjet section 16 moves from the first inkjet target to other inkjet target so that the calculation is carried out more preferentially with respect to inkjet targets positioned nearer to the first inkjet target, and the determination section 13 determines whether or not the main scanning direction movement time (Yt) is equal to or less than the sub scanning direction movement time (Xt), and determines an inkjet target, which satisfies Xt≦Yt, as a next inkjet target.

The order detection section 14 determines an inkjet target, which can be reached at a shortest distance from the first inkjet target, as a next inkjet target out of the next inkjet target candidates. Note that, in case where the determination section 13 carries out the determination more preferentially with respect to inkjet targets positioned nearer to the first inkjet target, the order determination section 14 determines a first next inkjet target candidate, having been determined first, as the next inkjet target candidate. Thus, in this case, the order determination section 14 may be omitted.

The inkjet control section 15 can move the inkjet section 16 relative to the inkjet target in accordance with the order in which ink is ejected to inkjet targets or can incline the inkjet section 16 in the main scanning direction or the sub scanning direction with the inkjet section 16 positioned opposite to the inkjet target. Further, the inkjet control section 15 can move the inkjet section 16 and can move the substrate including the inkjet target. In this manner, the movement is not particularly limited.

The inkjet section 16 ejects ink to the inkjet target. The inkjet section 16 is not particularly limited and a known arrangement may be suitably adopted.

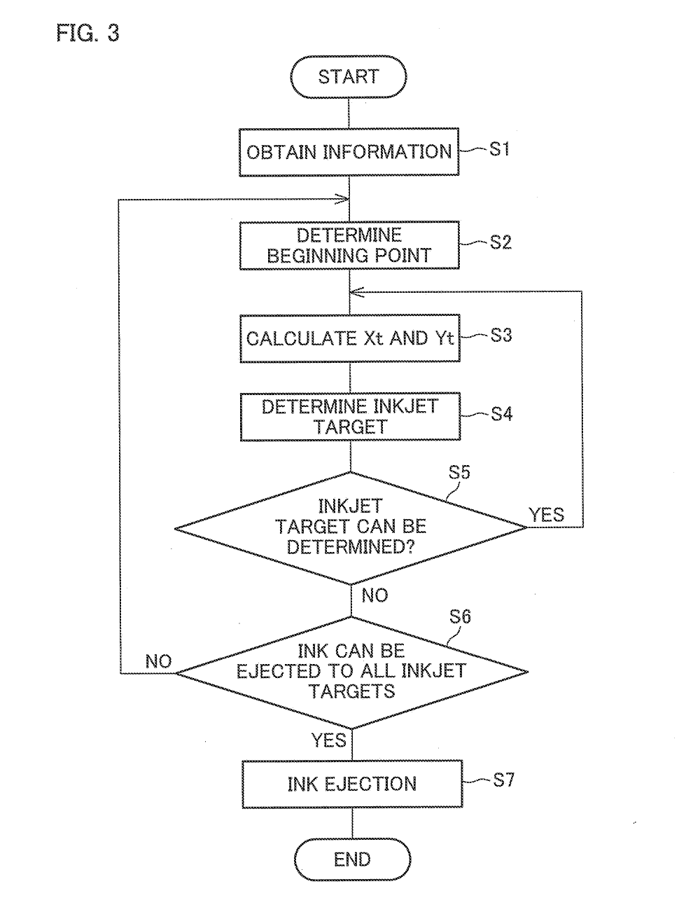

Next, a procedure in which the inkjet apparatus of the present embodiment is operated and how to control the inkjet apparatus of the present embodiment are described as follows with reference to FIG. 3.

(As to a Step S1)

First, the information input section 10 obtains information for determining an order in which ink is ejected to plural inkjet targets dotted on the medium (S1). First, as to each of the inkjet targets dotted on the substrate, its XY coordinate values on the substrate, lengths of the inkjet target in the X coordinate axis direction and the Y coordinate axis direction in case where the inkjet target has a rectangular shape, a speed at which the inkjet section 16 moves in the X coordinate axis direction and the Y coordinate axis direction are used as input information. Further, ink is ejected to the inkjet target in consideration not only for a distance at which the inkjet section 16 moves in the Y coordinate axis direction (i.g., a length of the inkjet target in the Y coordinate axis direction) but also for (i) a time taken for the inkjet section 16 to stop after reaching an X coordinate value of an inkjet position, (ii) a distance at which the inkjet section 16 moves in the Y coordinate axis for a period corresponding to the time taken for the inkjet section 16 to stop, acceleration and deceleration of the inkjet section 16 in moving into the X coordinate axis direction.

A set of inkjet targets whose ejection order has not been determined is a set R1, and an element thereof is indicated by P(i) where i=1 to n (n is indicative of the number of inkjet targets). Further, R2 is a set of inkjet targets whose ejection order has been determined as a target to which ink can be ejected while moving only in the Y coordinate axis direction, and an element thereof is PP(j)(k) where j=1 to s and k=1 to m. Note that, in case where an ejection head 20 begins to move only in the Y coordinate axis direction and subsequently changes its moving direction so that this movement is defined as “single main-scanning-direction movement”, “j” indicates the number of times the ejection head 20 moves in ejecting ink to PP(j)(k), and “s” indicates the number of entire times the ejection head 20 moves. Further, “k” indicates an ejection order of inkjet targets to which ink is ejected during the movement defined by “j”, and “m” indicates the number of inkjet targets to which ink is ejected during the movement defined by “j”. Note that, an initial value of each of “j” and “k” is 1.

(As to a Step S2)

Next, the determination section 13 determines the beginning point in accordance with the inputted information (S2). In determining the beginning point, for example, the inkjet targets are rearranged in accordance with the Y coordinate value of each inkjet target on the substrate. At this time, data sets can be rearranged in accordance with an ascending order or a descending order of the Y coordinate value for example. At this time, data sets are rearranged in such order that data sets whose Y coordinate value are larger are more previously arranged in case where a minus direction of the Y coordinate axis is the main scanning direction, and data sets are rearranged in such order that data sets whose Y coordinate value are smaller are more subsequently arranged in case where a plus direction of the Y coordinate axis is the main scanning direction. Further, in rearranging the inkjet targets, the inkjet targets can be rearranged sequentially from an inkjet target positioned nearest to the inkjet section 15 at a straight distance. Note that, there are various standards for rearranging the inkjet targets, and the standard is not particularly limited.

If a set including the rearranged inkjet targets is R1, the inkjet targets are rearranged so that an element of the set R1 is P(i) where i=1 to n (n is indicative of the number of inkjet targets). Further, a first element P(1) is selected and picked up from the set R1 so as to remove the first element P(1) from the set R1 and newly incorporate the first element P(1) into the set R2. At this time, an element of the set R1 is P(i) where i=2 to n, and an element of the set R2 is PP(j)(k)=P(1). Further, PP(j)(k) is a beginning point.

(As to a Process of S3)

Next, the determination section 13 selects an inkjet target candidate (S3). Specifically, the determination section 13 calculates a time required for the inkjet section 16 to move from PP(j)(k) to each inkjet target, which is an element of the set R1, i.e., to P(i) where i=2 to n, in the X coordinate axis direction and the Y coordinate axis direction. Further, such an element of the set R1 that the time taken to move in the X coordinate axis direction is equal to or less than the time taken to move in the Y coordinate axis direction is determined as an inkjet target candidate.

Note that, at this time, an order in which inkjet targets each of which is an element of the set R1 are determined is not particularly limited. In determining the order, inkjet targets positioned nearer to the beginning point may be preferentially determined. In this case, it is not necessary to determine whether all the inkjet targets satisfy Xt≦Yt or not, and an inkjet target which first satisfies Xt≦Yt is determined as a next inkjet target.

The following description explains how to calculate the time required for the inkjet section 16 to move from PP(j)(k) to each element of the set R1 in the X coordinate axis direction and the Y coordinate axis direction.

First, how to calculate a time taken to move in the Y coordinate axis direction is described. Herein, a time taken to move in the Y coordinate axis direction is Yt (seconds), a distance at which the inkjet section 16 moves in the Y coordinate axis direction is Y₁ (mm), and a constant speed at which the inkjet section 16 moves in the Y coordinate axis direction is a (mm/second). Under this condition, Yt is expressed by the following expression (1).

Yt=Y₁/a Expression (1)

Next, how to calculate a time taken to move in the X coordinate axis direction is described as follows. In moving in the X coordinate axis direction, four steps are carried out as acceleration, constant-speed movement, deceleration, and stoppage. When the time taken to move in the X coordinate axis direction is Xt, Xt is a total time required in carrying out the acceleration, the constant-speed movement, the deceleration, and the stoppage. The following shows times respectively required in the processes. Note that, the “stoppage” means a process in which the inkjet section 16 whose deceleration has been completed comes to rest in the X coordinate axis direction.

First, a time required in the acceleration is d₁, a time required in the deceleration is d₂, and a time required in the stoppage is c (second), and a distance at which the inkjet section 16 moves in the X coordinate axis direction at the time of the acceleration or the deceleration is X₂ (mm). When distance at which the inkjet section 16 moves in the X coordinate axis direction is X₁, a distance X₃ at which the inkjet section 16 moves at a constant speed is expressed by the following expression (2).

X₃=X₁−2×X₂ Expression (2)

At this time, when a speed in moving at a constant speed is b (mm/second), a time d₃ taken to move at the constant speed is expressed by the following expression (3).

d₃=(X₁−2×X₂)/b Expression (3)

Herein, Xt is a total time required in four processes, i.e., the acceleration, the constant-speed movement, the deceleration, and the stoppage, and this total time is expressed by the following expression (4).

Xt=d₃+d₁+d₂+c=(X₁−2×X₂)/b+(d₁+d₂)+c Expression (4)

Thus, such an inkjet target that its Yt and Xt expressed by the expressions (1) and (2) satisfy a condition expressed by the following expression (5) is selected as an inkjet target candidate.

X≦Yt Expression (5)

Note that, when the acceleration in the X coordinate axis direction is K₁ (mm/second²), a time d1 taken for a speed in moving in the X coordinate axis direction to attain the constant speed b (mm/second) is expressed by the following expression (6).

d₁=b/K₁ Expression (6)

Likewise, when the deceleration in the X coordinate axis direction is K₂ (mm/second²), the time d₂ required in the deceleration is expressed by the following expression (7).

d₂=b/K₂ Expression (7)

Further, the time c required in the stoppage can be calculated by actually operating the inkjet apparatus of the present invention and experimentally measuring the value thereof.

Note that, the time taken to move in the X coordinate axis direction and the time taken to move in the Y coordinate axis direction are calculated by using the parameters on the basis of the expressions (1) to (7), but the calculation method is not limited. For example, the time taken to move in the X coordinate axis direction and the time taken to move in the Y coordinate axis direction can be calculated in consideration also for other parameter. Alternatively, an extremely small value out of d₁, d₂, d₃, and c can be omitted.

(As to a Step S4)

Next, the order determination section 14 determines, out of the inkjet target candidates, an inkjet target, which can be reached from the beginning point in a shortest time, as a subsequent beginning point (S4). Note that, in S3, in case where the determination is carried out more preferentially with respect to the inkjet targets positioned nearer to the beginning point, an inkjet target which satisfies Xt≦Yt is determined as a next inkjet target. In this case, the determination section 13 can also determine the next inkjet target.

(As to a Step S5)

In S4, in case where a selectable element exists in the set R1, the element P(j), (2≦j≦n) of the selected inkjet target is removed from the set R1 so as to be added to the set R2 (PP(j)(k), (k=k+1)). Further, the process proceeds to S3 with the element used as a new beginning point.

In S4, in case where there is no selectable element in the set R1, this shows that there is no inkjet target which can eject ink during a single moving operation in the main scanning direction, so that the process proceeds to S6 (S5).

(As to a Step S6)

In case where all inkjet targets are selected as elements of the set R2, an order in which all dotted inkjet targets are to be processed is determined, the processes from S1 to S5 are ended, and the process proceeds to S7. While, in case where an unselected inkjet target exists in the set R2, the process returns to S2. After determining the new beginning point in S2, there is selected an inkjet target to which the ejection head 20 can eject ink during its movement in a direction opposite to the main scanning direction unlike the previous process. At this time, a value “j” indicative of the number of times the ejection head 20 moves in the main scanning direction is added, which results in j=j+1. Further, “k” indicative of an order in which ink is ejected to inkjet targets is reset to an initial value, which results in k=1 (S6).

As described above, the processes from S2 to S6 are carried out by the order determination section 14. In sequentially ejecting ink to all the dotted inkjet targets, the order determination section 14 determines an order in which ink is ejected to the dotted inkjet targets so as to minimize the processing time.

(As to a Step S7)

The inkjet control section 15 and the inkjet section 16 cause ink to be ejected to inkjet targets, so as to correspond to the number of times the inkjet section 16 moves in the main scanning direction, in accordance with an order of elements included in the set R2 determined in S1 to S6 (S7). As a result, in case where plural inkjet targets are dotted on the substrate as illustrated in FIG. 1 for example, ink is ejected in accordance with an order indicated by an arrow of FIG. 1.

FIG. 1 illustrates an inkjet route in accordance with the inkjet apparatus and the inkjet control method of the present embodiment. On the substrate 4, a plurality of pixel print targets 2 are dotted. The inkjet section 16 ejects ink to each of the pixel print targets 2 while moving along a route indicated by an arrow in FIG. 1. In case of moving between two inkjet targets, the inkjet section 16 finishes movement in the sub scanning direction X before finishing movement in the main scanning direction Y. Thus, according to the inkjet apparatus and the inkjet control method of the present embodiment, when the inkjet section 16 ejects ink, the inkjet section 16 moves in the main scanning direction Y at a constant speed, so that it is possible to eject ink to the pixel print target 2 accurately.

At this time, the inkjet control section 15 allows the inkjet section 16 to incline in the main scanning direction or the sub scanning direction with it positioned opposite to the inkjet target. Thus, a distance between the nozzles in the sub scanning direction can be reduced. As a result, it is possible to eject ink via plural nozzles to a single inkjet target. A distance between the nozzles in the sub scanning direction can be determined in accordance with an angle at which the inkjet section 16 inclines. Note that, the angle at which the inkjet section 16 inclines is not particularly limited and can be freely set. For example, the angle can be set in accordance with a size of the inkjet target, particularly, in accordance with its length in the X coordinate axis direction and a size of the ink droplet.

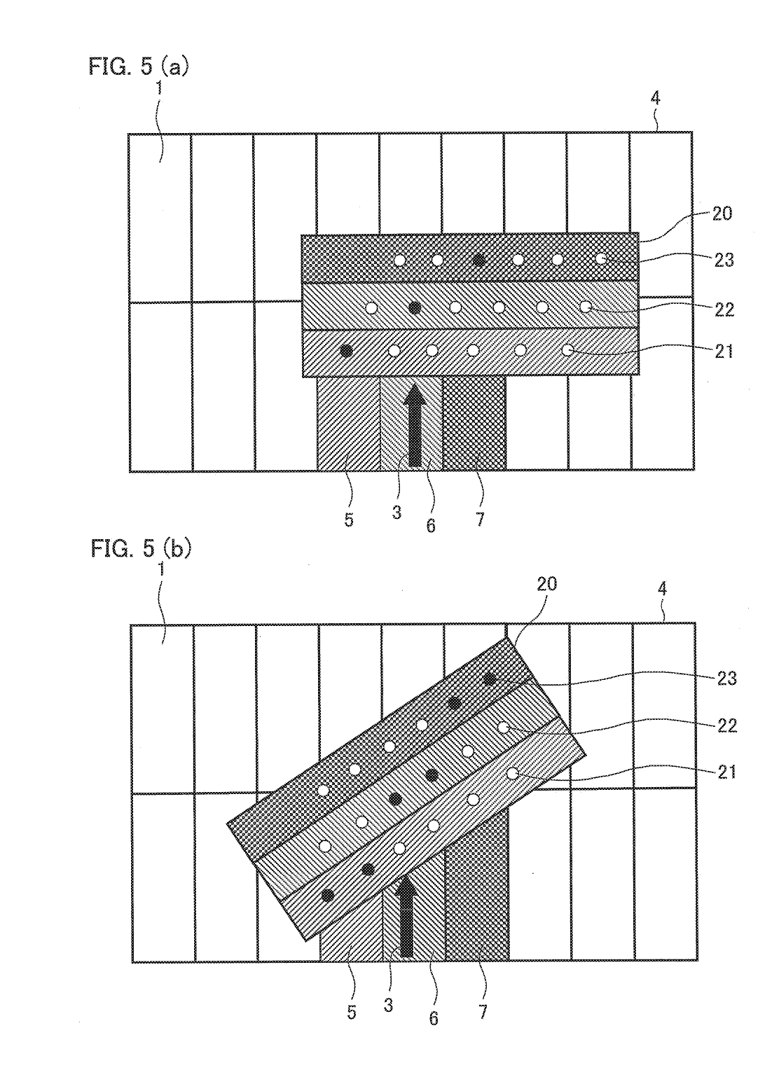

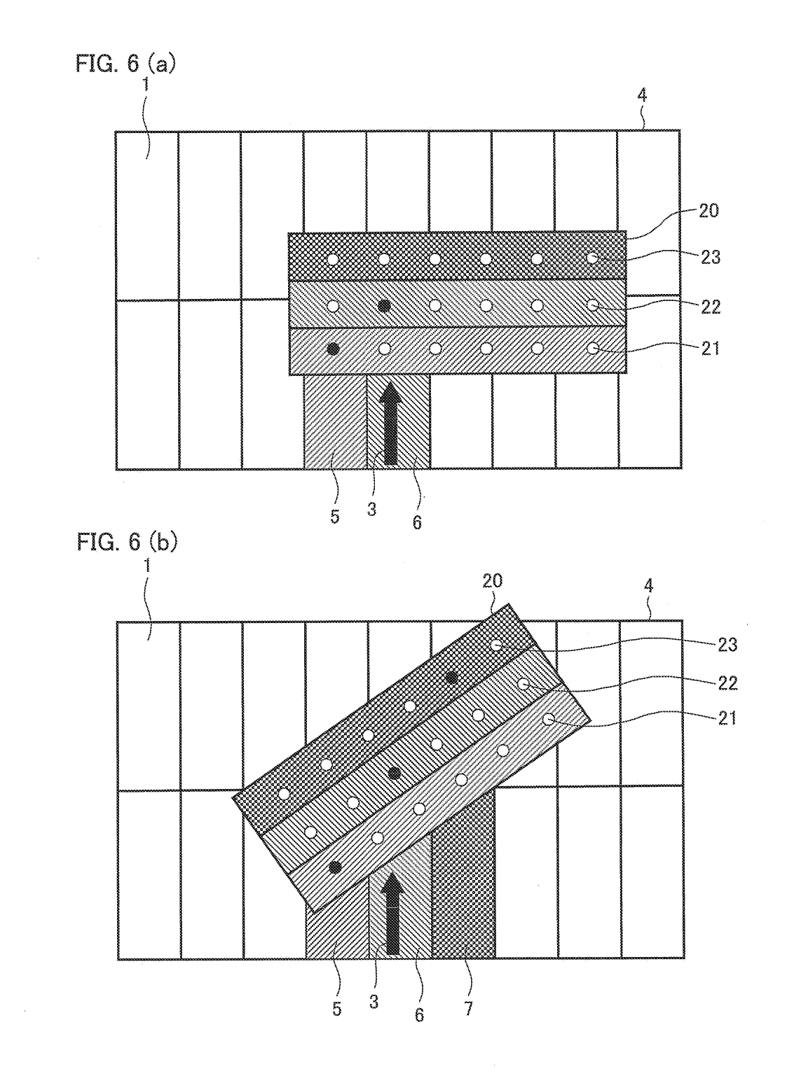

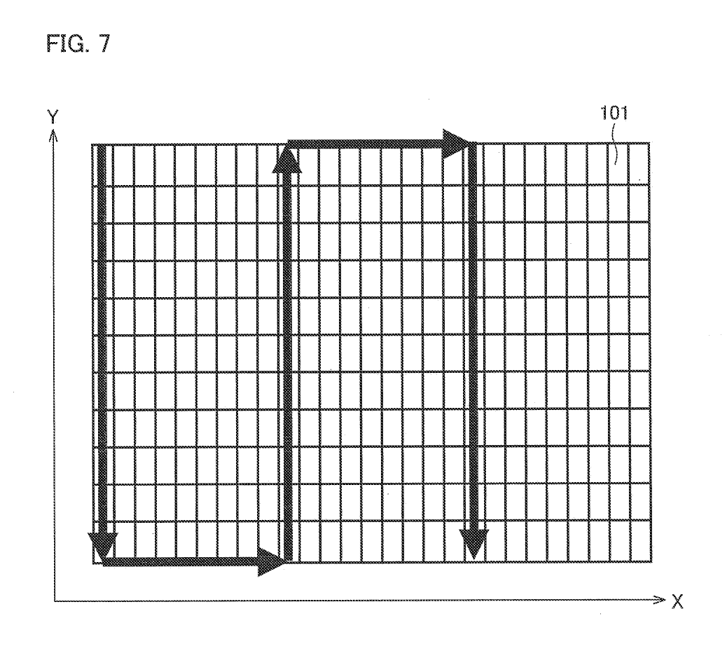

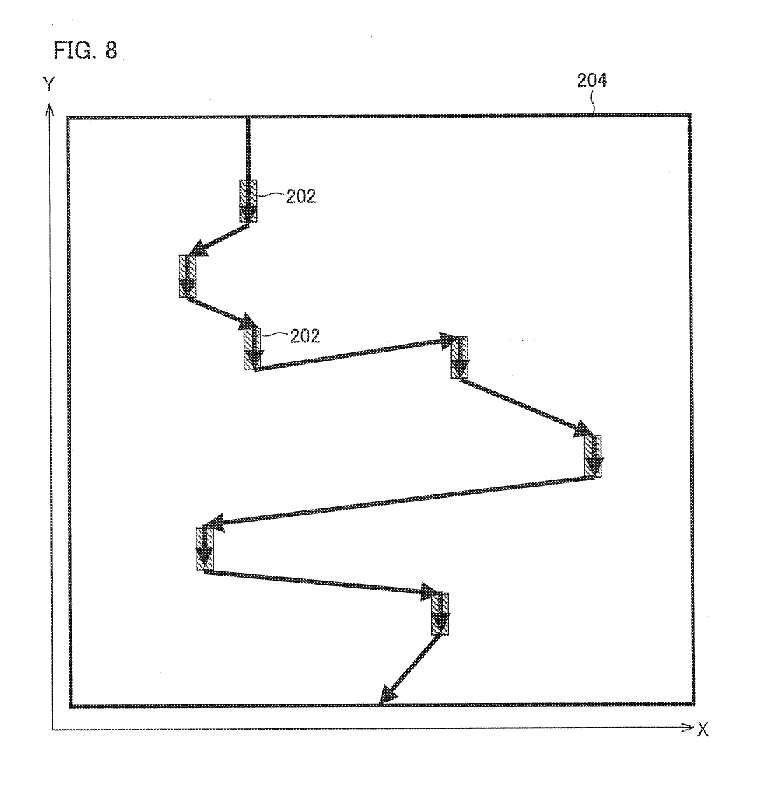

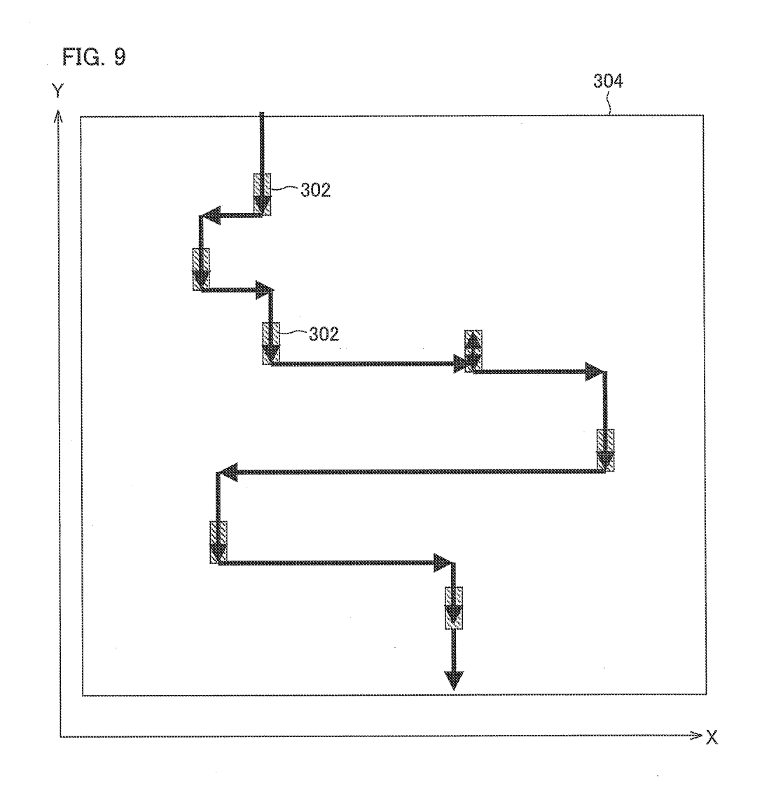

For example, as illustrated in FIG. 5(a) and FIG. 5(b), the inkjet apparatus and the inkjet control method of the present embodiment allow the inkjet section 16 to incline in the main scanning direction or the sub scanning direction with it positioned opposite to the inkjet target. The following describes an arrangement of nozzles before and after inclining the inkjet section 16 in the main scanning direction or the sub scanning direction. Note that, in FIG. 5 and FIG. 6, the ejection head 20 corresponds to the inkjet section 16.

As illustrated in FIG. 5(a), the ejection head 20 includes nozzles 21, 22, and 23, and is positioned opposite to the substrate 4. Note that, the ejection head 20 ejects ink while moving in a direction indicated by an arrow 3. Further, the substrate 4 has a plurality of pixels 1. Out of the pixels 1, pixels to which red (R) ink, greed (G) ink, and blue (B) ink are respectively ejected are referred to as a pixel 5, a pixel 6, and a pixel 7 respectively. In order to eject the red (R) ink, greed (G) ink, and blue (B) ink, the ejection head 20 includes: a plurality of nozzles 21; a plurality of nozzles 22; and a plurality of nozzles 23. Out of the nozzles, nozzles for ejecting inks to the pixels 5, 6, and 7 are indicated by black dots. That is, as illustrated in FIG. 5(a), the nozzle 21, the nozzle 22, and the nozzle 23 eject inks to the pixels 5, 6, and 7 respectively.

While, as illustrated in FIG. 5(b), the ejection head 20 is inclined, so that the two nozzles 21, the two nozzles 22, and the two nozzles 23 respectively eject inks to the pixels 5, 6, and 7.

While, in case where the angle of the ejection head 20 is fixed at 80°, an interval of ink droplets adjacent to each other is constant, so that the number of ejected droplets is adjusted for each nozzle so as to determine an amount of ink droplets for recovering the defective pixel. Also, the ejection head 20 of the inkjet apparatus having nozzle intervals each of which is 150 dpi is inclined by about 80°, so that the distance between the nozzles in the sub scanning direction is about 30 μm. When a width of the pixel is 100 μm, inks are ejected from at least two nozzles respectively so as to print in the same pixel. It is also possible to secure a total amount of droplets required in recovering the defective pixel by controlling the number of droplets ejected from the two nozzles.

Further, as illustrated in FIG. 4(b), in case where the pixel width is 300 μm, nine nozzles can be arranged so as not to be over the pixel width under the foregoing condition. In this case, even if a nozzle out of the nine nozzles is in an unfavorable state for example, it is possible to eject a desired amount of ink droplets by using eight nozzles. Note that, in FIG. 4(b), a direction in which the inkjet apparatus scans is indicated by an arrow 3.

Further, as illustrated in FIG. 6, if the inkjet apparatus of the present embodiment is used, in restoring a defective pixel, it is possible to restore not only a single-color defective pixel such as an uncolored pixel out of RGB pixels for example but also two defective pixels adjacent to each other, e.g. RG pixels, GB pixels, and BR pixels, whose defection is caused by color leakage between the pixels due to foreign substances such as dusts, or three defective pixels adjacent to one another, e.g., RGB pixels, GBR pixels, and BRG pixels, at the same time.

Thus, ejection heads 20 provided on the inkjet apparatus so as to correspond to respective colors are positioned near to one another, and nozzles of the ejection heads 20 are positioned so as to overlap one another at least in the main scanning direction, and each of the ejection heads 20 is inclined as described above, so that the inkjet interval virtually in the sub scanning direction can be made narrower. The positions of the nozzles of the ejection heads 20 are minutely adjusted so as to correspond to positions of pixels adjacent thereto so that defective pixels adjacent to one another can be restored with inks whose colors are different from one another, thereby restoring the defective pixels during single scanning operation using a plurality of inks different from one another.

For example, as illustrated in FIG. 6(a), the inkjet apparatus and the inkjet control method of the present embodiment allow two pixels adjacent to each other to be restored during a single scanning operation. In this case, it is possible to restore the pixels 5 and 6 adjacent to each other by using the nozzles 21 and 22 respectively. Further, as illustrated in FIG. 6(b), the inkjet apparatus and the inkjet control method of the present embodiment allow three pixels adjacent to one another to be restored during a single scanning operation. In this case, the ejection head 20 is inclined, so that it is possible to restore the pixels 5, 6, and 7 adjacent to one another by using the nozzles 21, 22, and 23 respectively.

### Embodiment 2

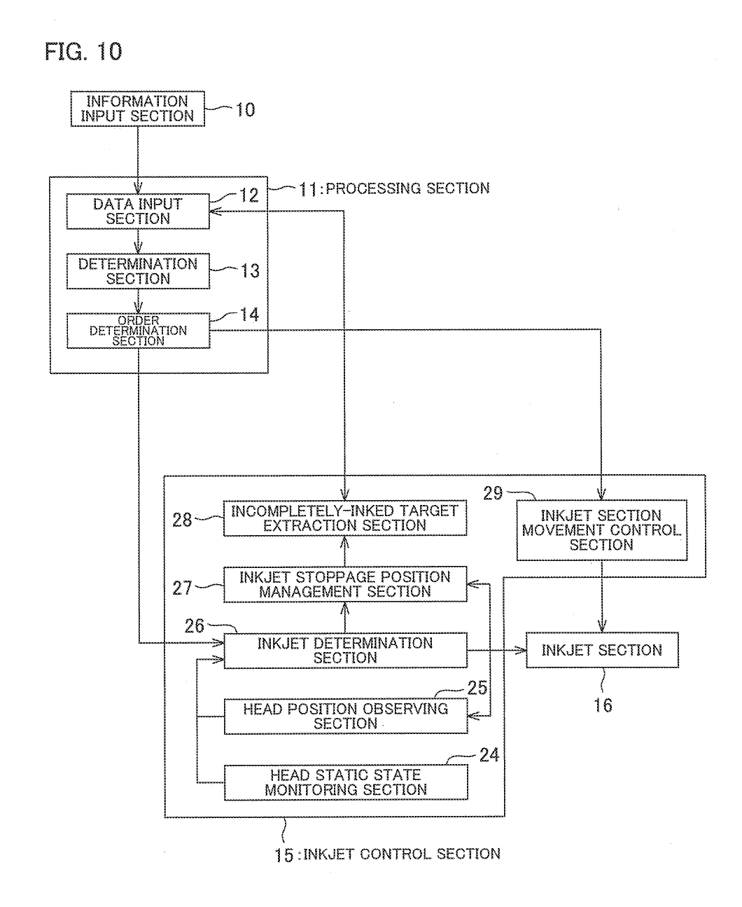

The following description explains another embodiment of the present invention with reference to FIG. 10 to FIG. 12, but the present invention is not limited to this. Note that, for convenience in description, the same reference numerals are given to members having the same functions as those of Embodiment 1, and descriptions thereof are omitted.

As described above, Embodiment 1 is arranged so that the inkjet control section 15 moves the position of the inkjet section 16 in accordance with the order in which ink is ejected to inkjet targets and inclines the inkjet section 16 in the main scanning direction or the sub scanning direction, in other words, the inkjet control section 15 controls the position of the inkjet section 16 relative to the inkjet target or placement of the inkjet section 16.

In the present embodiment, the inkjet control section 15 not only controls the position or the placement of the inkjet section 16 but also monitors an ejection state of the inkjet section 16 so as to give determination or the like concerning the ink ejection, in other words, the inkjet control section 15 monitors a state of the inkjet section 16 so as to control the ink ejection.

Specifically, as illustrated in FIG. 10, the inkjet apparatus of the present embodiment includes an information input section 10, a processing section 11, an inkjet control section 15, and an inkjet section 16 as in Embodiment 1. In addition, the inkjet control section 15 includes a head static state monitoring section 24, a head position observing section 25, an inkjet determination section 26, an inkjet stoppage position management section 27, an inkjet target extraction section 28, and an inkjet section movement control section 29.

In the inkjet control section 15, the head static state monitoring section 24 monitors whether the inkjet section 16 is in the static state or not while the inkjet section 16 is scanning on the substrate. Further, the head position observing section 25 always observes a position of the inkjet section 16 on the substrate. Note that, in the present specification, the “static state” means a state in which oscillation of the inkjet section 16 with respect to the medium does not exceed a predetermined distance range. The “predetermined distance range” means such a range that the inkjet section 16 allows ink to be landed on the inkjet target with high accuracy, and this range is not particularly limited. The distance range can be suitably set depending on the necessary landing accuracy and a size of the inkjet target.

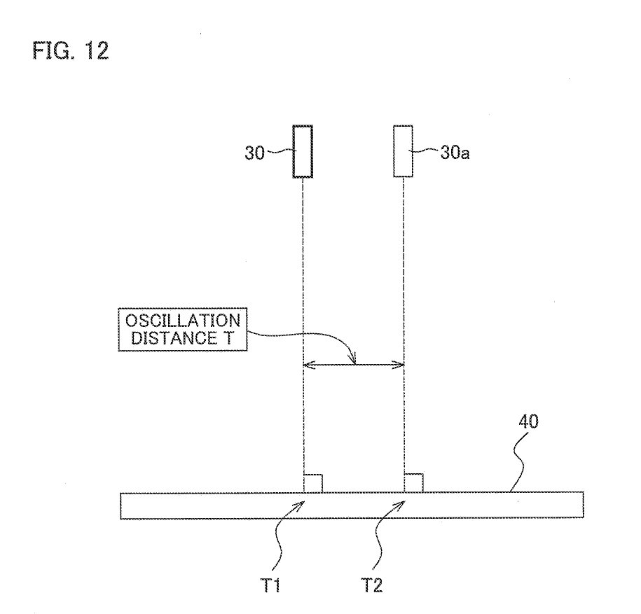

The oscillation distance can be calculated as follows. For example, as illustrated in FIG. 12, when the inkjet section 16 (not shown in FIG. 12) does not oscillate with respect to the medium 40 and a line (indicated by a dotted line in FIG. 12) is vertically drawn from a nozzle 30 (indicated by thick lines in FIG. 12) of the inkjet section 16 to the medium 40, a junction of the line and the medium 40 is T1 (reference point). Next, when the nozzle 30 of the inkjet section 16 which is monitored by the head static state monitoring section 24 (not shown in FIG. 12) is regarded as a monitored nozzle 30a as indicated by thin lines and a line vertically drawn from the monitored nozzle 30a to the medium 40, a junction of the line and the medium 40 is T2. At this time, the oscillation distance can be defined as a distance T between T2 and T1. In other words, the static state can be defined as a state in which the distance T between T2 and T1 (T=T2−T1) is positioned within the predetermined distance range. Note that, such an ideal static state that there is no oscillation means a state in which the nozzle 30 positioned at the reference point and the monitored nozzle 30a overlap each other so that the oscillation distance T=T2−T1=0.

As described above, the oscillation distance is not particularly limited, but it is preferable that the oscillation distance is within 1 μm. Further, in order to control the accuracy with which ink is landed from the inkjet section 16 so that deviation thereof is within ±5 μm, it is further preferable that the oscillation distance is within 0.3 μm.

In the inkjet control section 15, the head static state monitoring section 24 monitors whether the inkjet section 16 is in the static state or not at the time when the head position observing section 25 observes that the inkjet section 16 reaches an inkjet beginning point at which ejection of ink to the inkjet target is started. Further, in case where the inkjet determination section 26 determines that the inkjet section 16 is in the static state, ejection of ink from the inkjet section 16 is started so as to land the ink onto the inkjet target. While, in case where the inkjet determination section 26 determines that the inkjet section 16 is not in the static state (the inkjet section 16 oscillates), the ejection of ink is stopped so as not to eject ink to the desired inkjet target.

At this time, the head ejection stoppage position management section 27 picks up information, concerning a position at which the inkjet is stopped, from the head position observing section 25, and manages the information as a stoppage position. Note that, “to manage” means to save the positional information of the inkjet section 16 on the medium in case of stoppage of the ink ejection.

Further, the incompletely-inked target extraction section 28 extracts an inkjet target, with respect to which the ink ejection is stopped, in accordance with (i) the stoppage position managed by the head ejection stoppage position management section 27 and (ii) the positional information of each inkjet target which is inputted by the data input section 12. In order to eject ink again to the extracted inkjet target, the inkjet apparatus of the present invention moves the inkjet section 16 and causes the inkjet section 16 to eject ink to an inkjet target, to which ink has not been completely ejected, so as to land ink onto the inkjet target. Note that, the inkjet section 16 can be moved again and ink can be ejected again by inputting to the data input section 12 information concerning the inkjet target having been extracted by the incompletely-inked target extraction section 28.

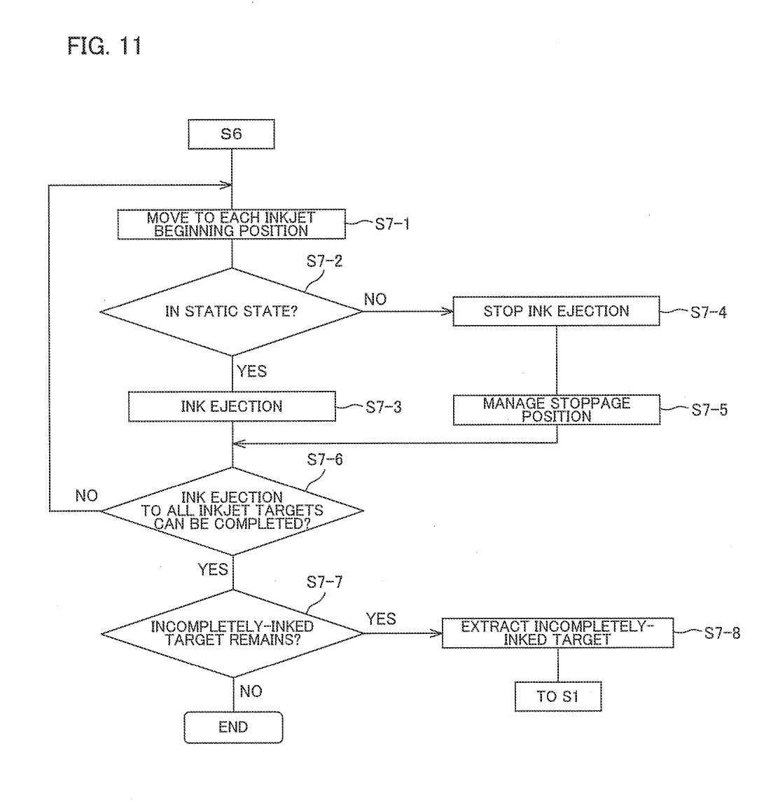

Next, with reference to FIG. 11, the following description explains a procedure in which the inkjet apparatus of the present embodiment is operated and how to control the inkjet apparatus of the present embodiment. Note that, as to the procedure in which the inkjet apparatus of the present embodiment is operated and how to control the inkjet apparatus of the present embodiment, processes S1 to S6 are the same as those of Embodiment 1. Thus, descriptions of S1 to S6 are omitted. Further, in S7, ink is ejected to inkjet targets, so as to correspond to the number of times the inkjet section 16 moves in the main scanning direction, in accordance with the order of elements included in the group R2 which has been determined in S1 to S6, as in Embodiment 1. Further, in S7 of the present embodiment, the inkjet can be controlled while monitoring the state of the inkjet section 16. With reference to the flowchart of FIG. 11, the following further details the process of S7 in the procedure in which the inkjet apparatus of the present embodiment is operated and how to control the inkjet apparatus of the present embodiment. Note that, S7 of the present embodiment includes sub-steps S7-1 to S7-8. Thus, the sub-steps S7-1 to S7-8 are described as follows.

(As to a Sub-Step S7-1)

The inkjet control section 15 moves the inkjet section 16 on the substrate toward a desired inkjet target in accordance with an order, saved in the order determination section 14, in which inkjet targets are to be processed (S7-1). At this time, the inkjet control section 15 causes the ink static state monitoring section 24 to always monitor the static state of the inkjet section 16 and causes the head position observing section 25 to always observe the position of the inkjet section 16.

(As to a Sub-Step S7-2)

In the inkjet control section 15, the inkjet determination section 26 determines whether the inkjet section 16 can eject ink or not in accordance with information concerning the static state, which information is provided from the head static state monitoring section 24, when the inkjet head 16 reaches the inkjet start point. In case where the inkjet section 16 is in the static state, the inkjet determination section 26 determines that it is possible to eject ink. In case where the inkjet section 16 is not in the static state, the inkjet determination section 26 determines to stop ejection of ink. Note that, “being in the static state” means a case where oscillation of the inkjet section 16 is within a predetermined range (1 μm for example) or a similar case.

(As to a Sub-Step S7-3)

In the inkjet control section 15, in case where the inkjet determination section 26 determines that the inkjet section 16 is in the static state, the inkjet section 16 lands ink onto a desired inkjet target (S7-3).

(As to a Sub-Step S7-4)

While, in case where the inkjet determination section 26 determines that the inkjet section 16 is not in the static state, the inkjet section 16 does not eject ink and passes above the desired inkjet target and then moves to a subsequent desired inkjet target (S7-4).

(As to a Step S7-5)

In case where ink is not ejected, an inkjet target's inkjet beginning point which is observed by the head position observing section 25 to find that any ink has not been ejected to the inkjet target is inputted to the inkjet stoppage position management section 27 so as to be saved and managed therein (S7-5).

(As a Sub-Step S7-6)

The inkjet control section 15 sequentially carries out the sub-steps S7-1 to S7-5, and moves the inkjet section 16 with respect to all the inkjet targets, and then finishes a series of inkjet processes (S7-6).

(As to a Sub-Step S7-7)

In the inkjet control section 15, there is determined whether the information concerning the inkjet beginning point to which ink has not been completely ejected is saved in the inkjet stoppage position management section 27 or not, and the sub-steps S7 are finished in case where the information is not saved (S7-7).

(As to a Sub-Step S7-8)

In case where the information concerning the inkjet beginning point to which ink has not been completely ejected is saved in the inkjet stoppage position management section 27, there is generated data, which can be inputted to the data input section 12 by the incompletely-inked target extraction section 28, in accordance with the information stored in the inkjet stoppage position management section 27. Further, the process returns to S1 using the data as information, and the inkjet section 16 is moved again, and ink is ejected and landed onto the inkjet target to which ink has not been completely ejected (S7-8).

The foregoing description explained the inkjet apparatus and the inkjet control method of the present invention taking Embodiments 1 and 2 as examples of the best modes, but the present invention is not limited to them. For example, it may be so arranged that the control explained in Embodiment 1 and the control explained in Embodiment 2 are switched as necessary, or it may be so arranged that the means included in the inkjet control section 15 explained in Embodiment 2 are partially omitted or other means is added to the inkjet control section 15 explained in Embodiment 2. Further, the present invention can be configured as follows.

In order to solve the foregoing problems, the inkjet apparatus of the present invention comprises inkjet means which is provided movably between a plurality of inkjet targets dotted on a medium so as to eject ink to each of the inkjet targets, and the inkjet apparatus is characterized in that: the inkjet means is movable in a main scanning direction and a sub scanning direction and moves in the main scanning direction at a constant speed, and the inkjet apparatus comprises: determination means for calculating a main scanning direction movement time (Yt) and a sub scanning direction movement time (Xt) in moving the inkjet means from a first inkjet target which is an arbitrary inkjet target to other inkjet target and for determining inkjet targets, each of which has the sub scanning direction movement time (Xt) equal to or less than the main scanning direction movement time (Yt), as next inkjet target candidates; and ejection order determination means for determining, out of the next inkjet target candidates, an inkjet target, which can be reached from the first inkjet target in a shortest time, as a next inkjet target.

Further, in order to solve the foregoing problems, the inkjet control method of the present invention controls an inkjet apparatus including inkjet means which is provided movably between a plurality of inkjet targets dotted on a medium so as to eject ink to each of the inkjet targets, the inkjet means being movable in a main scanning direction and a sub scanning direction and moving in the main scanning direction at a constant speed, and the inkjet control method is characterized by comprising the steps of: (i) calculating a main scanning direction movement time (Yt) and a sub scanning direction movement time (Xt) in moving the inkjet means from a first inkjet target which is an arbitrary inkjet target to other inkjet target and so as to determine inkjet targets, each of which has the sub scanning direction movement time (Xt) equal to or less than the main scanning direction movement time (Yt), as next inkjet target candidates; and (ii) determining, out of the next inkjet target candidates, an inkjet target, which can be reached from the first inkjet target in a shortest time, as a next inkjet target.

According to the arrangement, the determination means determines inkjet targets, each of which has the sub scanning direction movement time (Xt) equal to or less than the main scanning direction movement time (Yt), as next inkjet target candidates. Thus, in case where the inkjet means moves between two inkjet targets, the inkjet means finishes movement in the sub scanning direction before finishing movement in the main scanning direction. In this case, the inkjet means moves only in the main scanning direction in ejecting ink to the inkjet target. That is, ink is ejected without any change of the speed. Thus, ink can be ejected to the inkjet target with less acceleration and less deceleration, so that it is possible to eject ink with high accuracy. Further, the inkjet means moves in the main scanning direction without increasing or decreasing its moving speed, so that it is possible to decrease a load exerted to the inkjet means.

Further, the ejection order determination means determines, out of the next inkjet target candidates, an inkjet target, which can be reached from the first inkjet target in a shortest time, as a next inkjet target. Thus, the ejection order determination means determines the next inkjet target which can be reached earlier than the reference time, so that it is possible to carry out the inkjet process in a short processing time. As a result, it is possible to provide an inkjet apparatus and an inkjet control method each of which allows ink to be landed on each of the plural dotted inkjet targets with high accuracy and the inkjet process to be carried out in a short processing time.

In order to solve the foregoing problems, an inkjet apparatus of the present invention comprises inkjet means which is provided movably between a plurality of inkjet targets dotted on a medium so as to eject ink to each of the inkjet targets, and the inkjet apparatus is characterized in that: the inkjet means is movable in a main scanning direction and a sub scanning direction and moves in the main scanning direction at a constant speed, and the inkjet apparatus comprises determination means for calculating a main scanning direction movement time (Yt) and a sub scanning direction movement time (Xt) in moving the inkjet means from a first inkjet target which is an arbitrary inkjet target to other inkjet target, the calculation being more preferentially carried out with respect to inkjet targets positioned nearer to the first inkjet target, and for determining whether the sub scanning direction movement time (Xt) is equal to or less than the main scanning direction movement time (Yt) or not so as to determine an inkjet target, which satisfies Xt≦Yt, as a next inkjet target.

Further, in order to solve the foregoing problems, an inkjet control method of the present invention controls an inkjet apparatus including inkjet means which is provided movably between a plurality of inkjet targets dotted on a medium so as to eject ink to each of the inkjet targets, the inkjet means being movable in a main scanning direction and a sub scanning direction and moving in the main scanning direction at a constant speed, and the inkjet control method is characterized by comprising the step of calculating a main scanning direction movement time (Yt) and a sub scanning direction movement time (Xt) in moving the inkjet means from a first inkjet target which is an arbitrary inkjet target to other inkjet target, the calculation being more preferentially carried out with respect to inkjet targets positioned nearer to the first inkjet target, and for determining whether the sub scanning direction movement time (Xt) is equal to or less than the main scanning direction movement time (Yt) or not so as to determine an inkjet target, which satisfies Xt≦Yt, as a next inkjet target.

According to the arrangement, the determination means determines inkjet targets, each of which has the sub scanning direction movement time (Xt) equal to or less than the main scanning direction movement time (Yt), as next inkjet target candidates. Thus, in case where the inkjet means moves between two inkjet targets, the inkjet means finishes movement in the sub scanning direction before finishing movement in the main scanning direction. In this case, the inkjet means moves only in the main scanning direction in ejecting ink to the inkjet target. That is, ink is ejected without any change of the speed. Thus, ink can be ejected to the inkjet target with less acceleration and less deceleration, so that it is possible to eject ink with high accuracy. Further, the inkjet means moves in the main scanning direction without increasing or decreasing its moving speed, so that it is possible to decrease a load exerted to the inkjet means.

Further, the determination means determines whether the sub scanning direction movement time (Xt) is equal to or less than the main scanning direction movement time (Yt) or not so as to determine an inkjet target, which satisfies Xt≦Yt, as a next inkjet target, in such order that the determination is more preferentially carried out with respect to inkjet targets positioned nearer to the first inkjet target. Thus, when an inkjet target existing in a position satisfying Xt≦Yt is first found, the inkjet target is determined as a next inkjet target. Therefore, it is possible to determine the next inkjet target without using the ejection order determination means.

Further, as to an inkjet target which has not been determined as the next inkjet target as a result of the calculation to find whether the inkjet target satisfies Xt≦Yt or not at the time when the next inkjet target is determined, it is not necessary to carry out calculation and determination. As a result, it is possible to reduce the processing time.

As a result, it is possible to provide an inkjet apparatus and an inkjet control method each of which allows ink to be landed onto each of the plural dotted inkjet targets with high accuracy and allows the inkjet process to be carried out in a short processing time.

It is preferable to arrange the inkjet apparatus of the present invention so that: in case where a moving distance in a Y coordinate axis direction is indicated as Y₁ (mm), a constant moving speed in the Y coordinate axis direction is indicated as a (mm/second), a time required in acceleration in an X coordinate axis direction is indicated as d₁ (second), a time required in deceleration in the X coordinate axis direction is indicated as d₂ (second), a time required in stoppage in the X coordinate axis direction is indicated as c (second), each of a moving distance in the X coordinate axis direction in the acceleration and a moving distance in the X coordinate axis direction in the deceleration is indicated as X₂ (mm), and a speed at which constant movement is carried out in the X coordinate axis direction is indicated as b (mm/second), the determination means determines inkjet targets, each of which has the sub scanning direction movement time (Xt) calculated by an expression (I) and the main scanning direction movement time (Yt) calculated by an expression (II) so that a condition represented by an expression (III) is satisfied, as the next inkjet target candidates,

Xt=(X₁−2×X₂)/b+(d₁+d₂)+c (I)

Yt=Y₁/a (II)

Xt≦Yt (III).

Further, it is preferable to arrange the inkjet control method of the present invention so that: in case where a moving distance in a Y coordinate axis direction is indicated as Y₁ (mm), a constant moving speed in the Y coordinate axis direction is indicated as a (mm/second), a time required in acceleration in an X coordinate axis direction is indicated as d₁ (second), a time required in deceleration in the X coordinate axis direction is indicated as d₂ (second), a time required in stoppage in the X coordinate axis direction is indicated as c (second), each of a moving distance in the X coordinate axis direction in the acceleration and a moving distance in the X coordinate axis direction in the deceleration is indicated as X₂ (mm), and a speed at which constant movement is carried out in the X coordinate axis direction is indicated as b (mm/second), inkjet targets, each of which has the sub scanning direction movement time (Xt) calculated by an expression (I) and the main scanning direction movement time (Yt) calculated by an expression (II) so that a condition represented by an expression (III) is satisfied, is determined as the next inkjet target candidates,

Xt=(X₁−2×X₂)/b+(d₁+d₂)+c (I)

Yt=Y₁/a (II)

Xt≦Yt (III).

According to the arrangement, Xt and Yt of each of the plural inkjet targets are calculated in accordance with the expressions (I) and (II), so that the thus calculated values can be compared with each other. As a result, an inkjet target satisfying the condition indicated by the expression (III) is determined as a next inkjet target candidate. In other words, the inkjet apparatus can select an inkjet target to which ink can be ejected while moving at a constant speed.

It is preferable to arrange the inkjet apparatus of the present invention so that the inkjet means inclines in the main scanning direction or the sub scanning direction with the inkjet means positioned opposite to the inkjet target.

It is preferable to arrange the inkjet control method of the present invention so that the inkjet means inclines in the main scanning direction or the sub scanning direction with the inkjet means positioned opposite to the inkjet target.

According to the arrangement, the inkjet means inclines in the main scanning direction or the sub scanning direction with the inkjet means positioned opposite to the inkjet target, so that it is possible to decease a distance between the nozzles in the sub scanning direction. In other words, it is possible to increase or decrease the number of nozzles passing above a single inkjet target. As a result, it is possible to eject ink to the same inkjet target by using a plurality of nozzles. For example, in case of ejecting a large amount of ink to a single inkjet target, the inkjet means is inclined, so that it is possible to eject a necessary amount of ink at once by using a necessary number of nozzles for ejecting the necessary amount of ink. Further, it is possible to eject ink to the same inkjet target by using a plurality of nozzles. Thus, even if a part of the nozzles for ejecting ink becomes unable to eject ink, the rest of the nozzles in a normal state can eject ink to the inkjet target.

It is preferable to arrange the inkjet apparatus of the present invention so that the inkjet means ejects ink to a plurality of inkjet targets during a single scanning operation.

Further, it is preferable to arrange the inkjet control method of the present invention so that the inkjet means ejects ink to a plurality of inkjet targets during a single scanning operation.

According to the arrangement, ink can be ejected to a plurality of inkjet targets adjacent to each other during a single scanning operation for example. As a result, it is possible to reduce the entire processing time.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

As described above, in the inkjet apparatus and the inkjet control method of the present invention, the inkjet means can move with respect to the medium, and the inkjet apparatus and the inkjet control method of the present invention includes determination means (determination step) for carrying out at least a process for selecting a next inkjet target or inkjet target candidates to which ink is ejected subsequently to the first inkjet target which is an arbitrary inkjet target, and the determination means (the determination step) calculates a main scanning direction movement time and a sub scanning direction movement time in moving from the first inkjet target to other inkjet target and determines whether the sub scanning direction movement time is equal to or less than the main scanning direction movement time or not at least so as to select a next inkjet target or inkjet target candidates as a result of the foregoing determination.

As a result, it is possible to provide an inkjet apparatus and an inkjet control method each of which allows ink to be landed to plural dotted inkjet targets with high accuracy and allows an inkjet process to be carried out in a short processing time.

Further, in case where any factor of the device causes the inkjet means not to be in a static state when the inkjet means reaches the inkjet beginning point, the inkjet apparatus and the inkjet control method of the present invention allow the ejection of ink to be stopped. As a result, it is possible to prevent ink from being less accurately landed, thereby preventing the substrate from being unnecessarily tainted with ink.

Moreover, an inkjet target with respect to which ink ejection has been stopped can be extracted and the inkjet target can be filled with ink ejected thereafter. As a result, it is possible to form a high quality substrate whose all inkjet targets are filled with ink without remaining an inkjet target with respect to which ink has not been completely ejected.

In the present invention, the inkjet section ejects ink to an inkjet target while moving in the main scanning direction, corresponding to a printing direction, at a constant speed. As a result, ink can be landed onto each of plural dotted inkjet targets with high accuracy, and the inkjet process can be carried out in a short processing time. Thus, the present invention is applicable to a field for manufacturing (i) various kinds of inkjet apparatuses represented by a printer or a liquid crystal CF panel manufacturing apparatus and (ii) components thereof.

1. An inkjet apparatus, comprising inkjet means which is provided movably between a plurality of inkjet targets dotted on a medium so as to eject ink to each of the inkjet targets,
said inkjet apparatus being characterized in that:
the inkjet means is movable, in a main scanning direction and a sub scanning direction, relative to the medium,
said inkjet apparatus further comprising determination means for carrying out at least a process for selecting a next inkjet target or inkjet target candidates to which ink is ejected subsequently to a first inkjet target which is an arbitrary inkjet target, wherein
the determination means calculates a main scanning direction movement time and a sub scanning direction movement time in moving from the first inkjet target to other inkjet target and determines whether the sub scanning direction movement time is equal to or less than the main scanning direction movement time or not at least so as to select a next inkjet target or next inkjet target candidates as a result of that determination.

2. The inkjet apparatus as set forth in claim 1, wherein:
in case where the main scanning direction movement time of the inkjet means is indicated as Yt and the sub scanning direction movement time of the inkjet means is indicated as Xt, the determination means determines inkjet targets, each of which has Xt equal to or less than Yt (Xt≦Yt), as inkjet target candidates,
said inkjet apparatus further comprising ejection order determination means for determining, out of the next inkjet target candidates, an inkjet target, which can be reached from the first inkjet target in a shortest time, as the next inkjet target.

3. The inkjet apparatus as set forth in claim 1, wherein:
in case where the main scanning direction movement time of the inkjet means is indicated as Yt and the sub scanning direction movement time of the inkjet means is indicated as Xt, the determination means calculates Yt and Xt so that the calculation is more preferentially carried out with respect to inkjet targets positioned nearer to the first inkjet target and determines whether or not Xt is equal to or less than Yt (Xt≦Yt), and
the determination means determines an inkjet target, satisfying a condition represented by Xt≦Yt, as the next inkjet target.

4. The inkjet apparatus as set forth in claim 1, wherein:
in case where a moving distance in a Y coordinate axis direction is indicated as Y₁ (mm), a constant moving speed in the Y coordinate axis direction is indicated as a (mm/second), a time required in acceleration in an X coordinate axis direction is indicated as d₁ (second), a time required in deceleration in the X coordinate axis direction is indicated as d₂ (second), a time required in stoppage in the X coordinate axis direction is indicated as c (second), each of a moving distance in the X coordinate axis direction in the acceleration and a moving distance in the X coordinate axis direction in the deceleration is indicated as X₂ (mm), and a speed at which constant movement is carried out in the X coordinate axis direction is indicated as b (mm/second),
the determination means determines inkjet targets, each of which has the sub scanning direction movement time (Xt) calculated by an expression (I) and the main scanning direction movement time (Yt) calculated by an expression (II) so that a condition represented by an expression (III) is satisfied, as the next inkjet target candidates,
Xt=(X₁−2×X₂)/b+(d₁+d₂)+c (I)
Yt=Y₁/a (II)
Xt≦Yt (III).

5. The inkjet apparatus as set forth in claim 1, further comprising inkjet control means for carrying out at least such control that the inkjet means is moved relative to an inkjet target in accordance with an order, in which ink is ejected to the inkjet targets, and the inkjet means ejects ink to the inkjet target.

6. The inkjet apparatus as set forth in claim 5, wherein the inkjet control means includes: head static state monitoring means for monitoring whether the inkjet means is in a static state or not; and head position observing means for detecting a position of the inkjet means.

7. The inkjet apparatus as set forth in claim 6, further comprising inkjet determination means for determining whether the inkjet means is capable of ejecting ink in reaching an inkjet start point or not in accordance with a monitoring result of the head static state monitoring means and an observing result of the head position observing means.

8. The inkjet apparatus as set forth in claim 7, further comprising inkjet stoppage position management means for managing an inkjet stoppage position in accordance with the monitoring result of the inkjet determination means and the observing result of the head position observing means.

9. The inkjet apparatus as set forth in claim 8, wherein the inkjet control means includes incompletely-inked target extraction means for extracting an inkjet target with respect to which inkjet is stopped.

10. The inkjet apparatus as set forth in claim 9, wherein the inkjet means is moved again to the inkjet target extracted by the incompletely-inked target extraction means and is made to eject ink to the inkjet target.

11. The inkjet apparatus as set forth in claim 1, wherein the inkjet means inclines in the main scanning direction or the sub scanning direction with the inkjet means positioned opposite to the inkjet target.

12. The inkjet apparatus as set forth in claim 11, wherein the inkjet means ejects ink to a plurality of inkjet targets during a single scanning operation.

13. An inkjet control method of an inkjet apparatus including inkjet means,
said inkjet means being provided movably between a plurality of inkjet targets dotted on a medium so as to eject ink to each of the inkjet targets and being movable in a main scanning direction and a sub scanning direction and moves relative to the medium,
said inkjet control method comprising the determination step of carrying out at least a process for selecting a next inkjet target or inkjet target candidates to which ink is ejected subsequently to a first inkjet target which is an arbitrary inkjet target, said determination step being carried out at a stage before the inkjet means ejects ink, wherein:
in the determination step, there are calculated a main scanning direction movement time and a sub scanning direction movement time in moving from the first inkjet target to other inkjet target and there is determined whether the sub scanning direction movement time is equal to or less than the main scanning direction movement time or not at least so as to select a next inkjet target or next inkjet target candidates as a result of that determination.

14. The inkjet control method as set forth in claim 13, wherein:
in case where the main scanning direction movement time of the inkjet means is indicated as Yt and the sub scanning direction movement time of the inkjet means is indicated as Xt, inkjet targets, each of which has Xt equal to or less than Yt (Xt≦Yt), are determined as inkjet target candidates in the determination step,
said inkjet control method further comprising the ejection order determination step of determining, out of the next inkjet target candidates, an inkjet target, which can be reached from the first inkjet target in a shortest time, as the next inkjet target.

15. The inkjet control method as set forth in claim 13, wherein:
in case where the main scanning direction movement time of the inkjet means is indicated as Yt and the sub scanning direction movement time of the inkjet means is indicated as Xt, there are calculated Yt and Xt so that the calculation is more preferentially carried out with respect to inkjet targets positioned nearer to the first inkjet target and there is determined whether or not Xt is equal to or less than Yt (Xt≦Yt) in the determination step, and
an inkjet target, satisfying a condition represented by Xt≦Yt, is determined as the next inkjet target.

16. The inkjet control method as set forth in claim 13, wherein:
in case where a moving distance in a Y coordinate axis direction is indicated as Y₁ (mm), a constant moving speed in the Y coordinate axis direction is indicated as a (mm/second), a time required in acceleration in an X coordinate axis direction is indicated as d₁ (second), a time required in deceleration in the X coordinate axis direction is indicated as d₂ (second), a time required in stoppage in the X coordinate axis direction is indicated as c (second), each of a moving distance in the X coordinate axis direction in the acceleration and a moving distance in the X coordinate axis direction in the deceleration is indicated as X₂ (mm), and a speed at which constant movement is carried out in the X coordinate axis direction is indicated as b (mm/second),
inkjet targets, each of which has the sub scanning direction movement time (Xt) calculated by an expression (I) and the main scanning direction movement time (Yt) calculated by an expression (II) so that a condition represented by an expression (III) is satisfied, are determined as the next inkjet target candidates in the determination step,
Xt=(X₁−2×X₂)/b+(d₁+d₂)+c (I)
Yt=Y₁/a (II)
Xt≦Yt (III).

17. The inkjet control method as set forth in claim 13, further comprising the inkjet control step of carrying out at least such control that the inkjet means is moved relative to an inkjet target in accordance with an order, in which ink is ejected to the inkjet targets, and the inkjet means ejects ink to the inkjet target.

18. The inkjet control method as set forth in claim 17, wherein the inkjet control step includes: the head static state monitoring step of monitoring whether the inkjet means is in a static state or not; and the head position observing step of detecting a position of the inkjet means.

19. The inkjet control method as set forth in claim 18, further comprising the inkjet determination step of determining whether the inkjet means is capable of ejecting ink in reaching an inkjet start point or not in accordance with a monitoring result of the head static state monitoring step and an observing result of the head position observing step.

20. The inkjet control method as set forth in claim 19, further comprising the inkjet stoppage position management step of managing an inkjet position and an inkjet stoppage position in accordance with the monitoring result of the inkjet determination step and the observing result of the head position observing step.

21. The inkjet control method as set forth in claim 20, wherein the inkjet control step includes the incompletely-inked target extraction step of extracting an inkjet target with respect to which inkjet is stopped.

22. The inkjet control method as set forth in claim 21, wherein the inkjet means is moved again to the inkjet target extracted by the incompletely-inked target extraction step and is made to eject ink to the inkjet target.

23. The inkjet control method as set forth in claim 13, wherein the inkjet means inclines in the main scanning direction or the sub scanning direction with the inkjet means positioned opposite to the inkjet target.

24. The inkjet control method as set forth in claim 23, wherein the inkjet means ejects ink to a plurality of inkjet targets during a single scanning operation.
